(19) United States
(12) Patent Application Publication
(10) Pub. No.: US 2026/0100613 A1
(43) Pub. Date: Apr. 9, 2026

(54) STATOR FOR AN ELECTRIC MACHINE AND ELECTRIC MACHINE

(71) Applicant: MAHLE International GmbH, Stuttgart (DE)

(72) Inventors: Marc Fraas, Bietgheim-Bissingen (DE); Philipp Licht, Stuttgart (DE)

(21) Appl. No.: 19/111,773

(22) PCT Filed: Sep. 14, 2023
(86) PCT No.: PCT/EP2023/075334

§ 371 Date: Mar. 13, 2025

(30) Foreign Application Priority Data
Sep. 14, 2022 (DE) 10 2022 209 640.1

(51) Int. Cl. H02K 1/20; H02K 1/16; H02K 5/20

(52) U.S. Cl. CPC H02K 1/20; H02K 1/16; H02K 5/20

(57) ABSTRACT

A stator includes a housing surrounding a housing interior. The stator also includes a laminated core comprising a plurality of laminations stacked along an axial direction. The laminated core is positioned within the housing interior. The stator further includes a gap between the laminated core and the housing—the gap forming a fluid path for a cooling medium to dissipate waste heat from the stator. The stator includes a rib structure arranged on an outer periphery of the laminated core. The outer periphery defines an inner radial boundary of the fluid path. The rib structure includes a plurality of ribs that projects radially outward into the fluid path to deflect the cooling medium as the cooling medium flows.

### CROSS REFERENCE TO RELATED APPLICATIONS

This application claims priority to International Patent Application No. PCT/EP2023/075334, filed on Sep. 14, 2023, and German Patent Application No. 102022209640.1, filed on Sep. 14, 2022, the contents of both of which are hereby incorporated by reference in their entirety.

### TECHNICAL FIELD

The invention relates to a stator for an electrical machine and to an electrical machine with such a stator.

### BACKGROUND

Stators for electrical machines usually carry coil windings by means of which a magnetic field can be generated to drive the rotor of the same electrical machine by magnetic interaction. Furthermore, such stators often include a so-called laminated core made of stator laminations stacked on top of each other, which can be used to influence the magnetic field lines of the magnetic field generated by the stator. This allows the coupling between the magnetic field generated by the stator and the magnetic field generated by the rotor to be optimized.

When the electric motor or the stator is in operation, especially when the stator coils are energized, waste heat is generated that must be dissipated to prevent overheating and the associated damage or even destruction of the stator. It is known to conduct a liquid or gaseous cooling medium through the stator laminations of the laminated core, which absorbs the waste heat and thus dissipates it from the stator.

In view of this, U.S. Pat. No. 10,158,263 B2 proposes forming openings in the stator laminations through which the cooling medium—such as oil—can flow.

Similar mechanisms for cooling the stator are known from CN 110808645 A, from WO 2021121360 A1 and from KR 20200102253 A.

### SUMMARY

What all these cooling mechanisms have in common is that they are relatively expensive to implement and thus involve considerable additional costs.

It is therefore an object of the present invention to provide an improved embodiment for a stator for an electrical machine in which the aforementioned problem is addressed. In particular, an improved stator is to be created in which a cooling mechanism is provided for dissipating waste heat, which is technically relatively simple to construct and can therefore be realized cost-effectively.

This object is achieved by the scope of the independent claims. Preferred embodiments are the scope of the dependent claims.

The basic idea of the invention is therefore to provide a rib structure with several ribs on the outer periphery of a laminated core formed by several stator laminations stacked axially on top of one another, which, together with the stator housing, define a fluid path through which a liquid or gaseous cooling medium in the form of a fluid, in particular oil, can be felt. The fluid path is bounded radially on the inside by the outer periphery of the laminated core and can also be bounded radially on the outside by the inner periphery of the housing. The outer periphery of the laminated core is therefore arranged radially at a distance from the stator housing, allowing the fluid path to form a cooling path or cooling channel.

By means of the aforementioned ribs formed on the outer periphery of the laminated core, which project into the fluid path according to the invention, so-called flow-directing elements are realized, which cause a deflection of the cooling medium when it flows through the fluid path. This results in an improved thermal coupling of the cooling medium to the material of the laminated core or the stator laminations forming the laminated core. This is accompanied by an improved transfer of waste heat from the laminated core or the stator laminations to the cooling medium. This ensures that the heat generated by the stator laminations is efficiently transferred to the cooling medium. Since the rib structure with the ribs on the outer periphery of the laminated core can be provided in a technically simple manner, for example by integrally forming them on the individual stator laminations, the said fluid path can be realized in a technically simple manner with the desired efficient thermal coupling to the stator laminations.

In detail, a stator for an electric machine according to the invention comprises a housing surrounding a housing interior. Furthermore, the stator comprises several, that is to say at least three, stator laminations which are arranged in the housing interior and are stacked along an axial direction, preferably resting axially against one another, and which together form a laminated core of the stator. At least one stator laminate can be formed by a sheet metal molding made of a metal. This makes it possible to manufacture the rib structure directly during the production of the sheet metal part, for example by means of a punching process. This applies preferably to several or even all of the stator laminations in the laminated core. The ribs of the rib structure can therefore be integrally formed on the laminated core or on its stator laminations.

In the stator according to the invention, the laminated core is arranged radially at a distance from the housing. A radial direction is perpendicular to the axial direction, preferably away from a center longitudinal axis of the stator that extends along the axial direction. This creates a radial gap between the housing and the laminated core, through which a cooling medium can flow to cool the stator.

In a preferred embodiment of the invention, the ribs lie radially on the outside of the housing. This allows the housing to form a radially outer boundary of the fluid channel. This eliminates the need for a separate fluid channel, which results in cost savings during stator production.

It is particularly preferred that at least two different stator laminations of the laminated core each have at least one rib of the rib structure formed on them. This will ensure that the cooling medium is evenly deflected.

The ribs of the rib structure are preferably arranged in a grid-like pattern on the outer periphery of the laminated core. In this way, the cooling medium flowing through the fluid path is deflected particularly often, resulting in a particularly effective thermal coupling to the stator laminations.

In another preferred embodiment, several, preferably all, of the ribs are arranged on the outer periphery in such a way that these ribs divide the fluid path into several partial fluid paths. By providing the aforementioned partial fluid paths, an even distribution of the cooling medium over the fluid path and thus an even removal of heat from the laminated core can be achieved. This ensures that the stator laminations are cooled evenly.

According to a favorable further development of the stator according to the invention, at least one, preferably several, particularly preferably all, of the ribs is/are elongated and extend along a longitudinal direction running parallel to the axial direction. Alternatively or additionally, at least one, preferably several, particularly preferably all, of the ribs can be web-like in this further development.

Several, preferably all, of the ribs of the rib structure, in particular both axial and radial, are arranged at a distance from each other. This ensures that the fins do not obstruct the flow of the cooling medium through the fluid path too much, but at the same time it ensures that the desired deflection of the cooling medium takes place for the purpose of improved heat absorption.

In a preferred embodiment, a distance between two ribs neighboring in the peripheral direction, measured along the peripheral direction, is at least twice, preferably at least three times, a width of at least one of these two ribs, measured perpendicularly to the axial direction, preferably in the peripheral direction. This is an advantageous way of ensuring that there is a sufficiently large gap between the individual ribs, also in the peripheral direction, through which the cooling medium can flow.

According to a favorable further development, at least on a first stator laminate and on a second stator laminate, axially adjacent to the first stator laminate, of the laminated core, in each case at least two, preferably several, first or second of the ribs of the rib structure are arranged at a distance, preferably equidistant, from one another. In this further development, the first ribs of the first stator laminate are arranged in a peripheral direction of the stator offset to the second ribs of the second stator laminate. This way, the cooling medium can be deflected multiple times as it flows through the fluid path without causing an excessive pressure loss in the cooling medium.

According to a favorable further development, an extension of a gap, measured along the peripheral direction, between at least a first rib and a second rib axially adjacent to this first rib, is at least 0.7 times, preferably at least 0.9 times, particularly preferably at least 1 times, a width of the first and/or second rib measured along the peripheral direction. “At least 1 times” means that the extension of the gap between them should be at least the same value as the width of the first or second rib. This further development advantageously prevents the flow through the fluid path from being too severely impeded by the existing rib structure and, in particular, from causing an excessive pressure drop in the cooling medium.

In another preferred embodiment, at least two first and at least two second stator laminations follow one another along the axial direction. This variant is particularly simple and therefore also particularly cost-effective.

The laminated core can therefore preferably include of at least two first and at least two second stator laminations.

In a preferred embodiment, the rib structure extends over the entire outer periphery of the laminated core. This supports a favorable uniform distribution of the cooling medium across the stator laminations.

According to a favorable further development, a fluid inlet for introducing the fluid into the fluid path and a fluid outlet for discharging the fluid from the fluid path after it has flowed through the fluid path are present on the housing. Alternatively or additionally, in this further development, the ribs of the rib structure are designed and aligned with one another such that the cooling medium flows from the fluid inlet to the fluid outlet along a main flow direction, which extends along the axial direction or along a peripheral direction of the stator that is perpendicular to the axial direction. This is a particularly effective way of cooling the stator laminations of the laminated core.

The fluid inlet and the fluid outlet are preferably arranged on axial end faces of the stator, in particular the housing of the stator, that are located opposite each other along the axial direction. This enables an axial flow through the gap between the housing and the laminated core.

According to another advantageous further development, the fluid inlet and the fluid outlet are arranged at a distance from one another on a peripheral side of the stator, in particular of the housing. This allows a flow through the gap between the housing and the laminated core in the peripheral direction.

To ensure that all outer peripheral sections of the laminated core are subjected to the desired cooling, the fluid inlet and the fluid outlet can be arranged at intervals from each other, particularly in the axial direction or/and in the peripheral direction.

According to an advantageous further development of the stator according to the invention, the fluid inlet and the fluid outlet can be located opposite each other in the peripheral direction. This ensures an even flow of the cooling medium through the fluid path, in particular along the peripheral direction of the stator, with the rib structure also ensuring that the cooling medium is distributed in the axial direction. This allows the stator to be cooled particularly efficiently and evenly, both axially and in the peripheral direction.

Alternatively or in addition, the fluid inlet and the fluid outlet can be arranged axially at the same height. This can be particularly advantageous when the available space is limited. Alternatively, the fluid inlet and outlet can also be arranged axially offset to one another. This ensures not only a flow in the peripheral direction but also a favorable axial flow.

The invention also relates to an electrical machine, in particular an externally excited electrical synchronous machine. The machine comprises a stator, as presented above and in accordance with the invention, and a rotor that is arranged in the housing interior and can be magnetically coupled or is coupled to the stator. The rotor is designed to rotate around an axis that extends in an axial direction in relation to the stator. The advantages of the stator according to the invention as explained above are therefore transferred to the electrical machine according to the invention.

In a preferred embodiment of the machine according to the invention, the rotor is arranged radially at a shorter distance from the axis of rotation than the stator. In such an electrical machine designed as an internal rotor, it is ensured that the rotor does not block the space needed to form the fluid path between the outer periphery of the laminated core and the stator housing.

Further important features and advantages of the invention are apparent from the dependent claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

The following is shown-schematically in each case-in the images below:

FIG. 1 shows an example of an electrical machine according to the invention, with an electrical stator according to the invention in a longitudinal section,

FIG. 2 shows a partial perspective view of the machine in FIG. 1, and

FIG. 3 shows the laminated core of the stator in FIG. 1 with the rib structure essential to the invention, shown separately.

### DETAILED DESCRIPTION

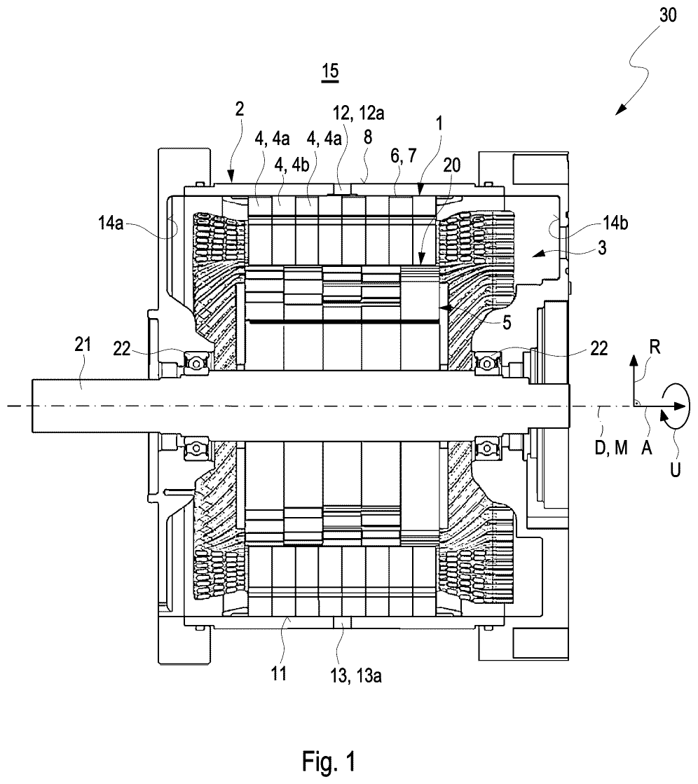

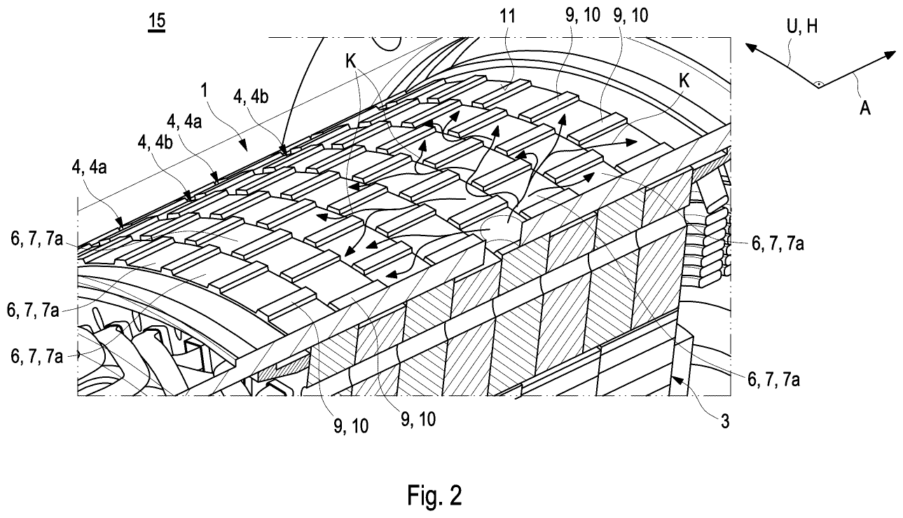

FIGS. 1 and 2 show an example of an electrical machine 30 according to the invention, which may be an externally excited electrical synchronous machine.

FIG. 1 shows a longitudinal section, while FIG. 2 shows a partial view in perspective. The electric machine 30 comprises an exemplary stator 1 according to the invention. The stator 1 comprises a housing 2 surrounding a housing interior 3. A rotor 20 is arranged in the housing interior 3, which is designed to be rotatable about an axis of rotation D extending along an axial direction A with respect to the stator 1. For this purpose, the rotor 20 can comprise a rotor shaft 21, which is rotatably mounted on the housing 2 of the stator 1 by means of a bearing device 22. Rotor coils that can be energized electrically in a rotationally fixed manner can be arranged on the rotor shaft 21 to generate a magnetic rotor field. Alternatively, however, it is also conceivable to arrange permanent magnets.

Furthermore, the stator 1 comprises a plurality of stator laminations 4 which are arranged in the housing interior 3, are stacked on top of one another in an axial direction A, rest axially against one another and together form a laminated core 5 of the stator 1. The stator laminations 4 can each have an annular geometry in a plane perpendicular to the axial direction A. The axial direction A extends along a common center longitudinal axis M of the rotor 20 and stator 1. A radial direction R runs perpendicular to the axial direction A away from the center longitudinal axis M of the stator 1, a peripheral direction U runs perpendicular to the axial direction A and perpendicular to the radial direction R around the center longitudinal axis M. The center longitudinal axis M forms the axis of rotation D of the rotor shaft 21 and thus of the entire rotor 20.

The ring-shaped stator laminations 4 can each be arranged concentrically to the center longitudinal axis M. The stator laminations 4 can be formed by sheet metal moldings. Electrically energizable stator coils (not shown) can be formed in the conventional manner on the laminated core 5 or on its stator laminations 4, radially on the inside, to generate a magnetic stator field. For this purpose, a plurality of stator teeth (not shown) can be formed on the stator laminations radially inward along the peripheral direction U to carry a coil winding forming the stator coils.

According to FIGS. 1 and 2, the laminated core 5 with the stator laminations 4 is arranged radially at a distance from the housing 2 of the stator 1. A radial gap 6 for cooling the stator 1 is formed between the housing 2 and the laminated core 5, through which gap 6 a fluid path 7 can be passed through by a cooling medium K, which preferably has a hollow cylindrical geometry.

Furthermore, the stator 1 according to FIG. 2 comprises a rib structure 9 for deflecting the cooling medium K as it flows through the fluid path 7. This rib structure 9 is arranged on an outer periphery 11 of the laminated core 5, which circumscribes the fluid path 7 radially on the inside, and extends over the entire outer periphery 11 of the laminated core 5.

The rib structure 9 comprises a plurality of ribs 10 that project outwards from the laminated core 5 and into the fluid path 7 along the radial direction R. The ribs 10 of the rib structure 9 are integrally formed on the laminated core 5 or on their stator laminations 4. In other words, the respective stator laminations 4 and the ribs 10 provided on this stator lamination 4 are designed as a single piece of material. The ribs 10 are arranged on the outer periphery 11 in such a way that they divide the fluid path 7 into several partial fluid paths 7a. The ribs 10 mentioned earlier form a boundary of these partial fluid paths 7a. In the example scenario, the ribs 10 also rest radially against the housing 2. Thus, the housing 2 forms a radially outer boundary of the fluid channel 7. By means of the aforementioned ribs 10 of the rib structure 9, so-called flow-directing elements are realized which cause a deflection of the cooling medium K when flowing through the fluid path 7.

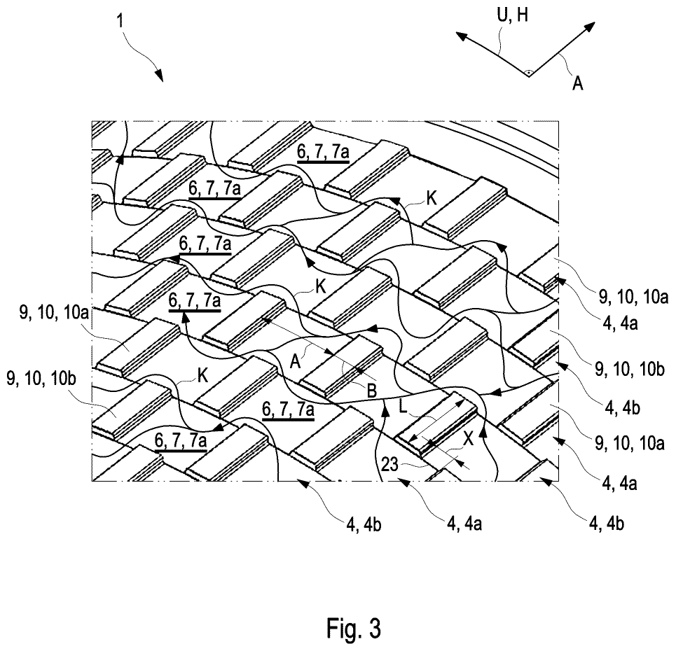

FIG. 3 shows the laminated core 5 with the rib structure 9 in a separate illustration. The ribs 10 of the rib structure 9 can therefore be arranged in a grid-like pattern on the outer periphery 11 of the laminated core 5. As can be further seen from FIG. 3, the individual ribs 10 are elongated and extend along a longitudinal direction L, which is parallel to the axial direction A. The ribs 10 are thus designed in the longitudinal direction L in the form of a web. In the example, all ribs 10 of the rib structure 9 are spaced both axially and radially. A length L of the individual ribs 10, measured along the axial direction A, is at least twice, preferably at least three times, a width B of the respective rib 10, measured along the peripheral direction U, i.e. perpendicular to the axial direction A. A distance A, measured in the peripheral direction U, between two ribs 10 that are neighboring in the peripheral direction U, is at least twice, preferably at least three times, a width B, measured in the peripheral direction U, of at least one of these two ribs 10.

In the example scenario, the individual stator laminations 4 are also formed by first and second stator laminations 4a, 4b, which follow one another alternately along the axial direction A and are in axial contact with one another. Adjacent stator laminations 4, 4a, 4b are electrically isolated from each other. Axially adjacent stator laminations 4, 4a, 4b can be glued together, in particular using an electrically insulating adhesive, but they can also be punch-bundled. Other suitable types of connection may also be used.

As can be seen in particular from the representation of FIG. 3, a plurality of first portions 10a of the ribs 10 of the rib structure 9 are arranged on the first stator laminations 4, 4a respectively along the peripheral direction U at a distance from and equidistantly from one another. Accordingly, on the second stator laminations 4, 4a, several second 10b of the ribs 10 of the rib structure 9 are arranged at intervals along the peripheral direction and equidistant from one another. Furthermore, the first ribs 10a of the first stator laminations 4, 4a are offset with respect to the peripheral direction U of the stator 1 relative to the second ribs 10b of the second stator laminations 4b, 4.

A dimension X, measured in the peripheral direction U, of a gap 23 between at least one first rib 10a and one second rib 10b axially adjacent to this first rib 10b is at least 0.7 times, preferably at least 0.9 times, particularly preferably at least 1 times, a width B of the first rib 10a measured along the peripheral direction U.

As shown in FIG. 1, the housing 2 may include a fluid inlet 12 for introducing the fluid into the fluid path 7 and a fluid outlet 13 for discharging the fluid from the fluid path 7 after it has passed through it. The fluid inlet 12 and the fluid outlet 13 are arranged at a distance from each other on one peripheral side 8 of the housing 2. The fluid inlet 12 and the fluid outlet 13 can be realized by openings 12a, 13a formed in the housing 2 on the periphery, via which the gap 6 forming the fluid path 7 communicates with the external environment 15 of the housing 2. As shown in FIG. 1, the fluid inlet 12 and the fluid outlet 13 can be located opposite each other in the peripheral direction U, i.e. at a peripheral angle of 180° measured along the peripheral direction U. Furthermore, the fluid inlet 12 and the fluid outlet 13 can be arranged axially at the same height as shown, but it is also possible to arrange them offset with respect to the axial direction A (not shown).

The ribs 10 of the rib structure 9 are designed and aligned with one another in such a way that the cooling medium K can flow along a main flow direction H from the fluid inlet to the fluid outlet 13, which runs along the peripheral direction U of the stator 1. In the example, the fluid inlet 12 and the fluid outlet 13 are arranged axially at the same height on the housing 2. However, it is also conceivable to arrange the fluid inlet 12 and the fluid outlet 13 at a distance from each other in the axial direction A.

In a further variant, not represented in the figures, the fluid inlet 12 and the fluid outlet 13 can be arranged on axial end faces 14a, 14b of the housing 2 that are located opposite each other in the axial direction A. In this case, the main flow direction H is also parallel to the axial direction A.

In the example of the figures, in machine 30 the rotor 20 is arranged radially at a shorter distance from the axis of rotation D than the stator 1, i.e. the machine 30 is designed as a so-called internal rotor.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, ”in examples,“ ”with examples,“ ”various embodiments,“ ”with embodiments,“ ”in embodiments,“ or ”an embodiment,“ or the like, means that a particular feature, structure, or characteristic described in connection with the example/embodiment is included in at least one embodiment. Thus, appearances of the phrases ”examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A stator for an electric machine, comprising:
a housing surrounding a housing interior;
a laminated core comprising a plurality of laminations stacked along an axial direction, the laminated core disposed within the housing interior;
a gap between the laminated core and the housing, the gap forming a fluid path for a cooling medium to dissipate heat from the stator; and
a rib structure arranged on an outer periphery of the laminated core, the outer periphery defining an inner radial boundary of the fluid path,
wherein the rib structure includes a plurality of ribs that projects radially outward into the fluid path to deflect the cooling medium as the cooling medium flows.

2. The stator according to claim 1, wherein at least one of the ribs rest radially on an outside of the housing.

3. The stator according to claim 1, wherein at least one rib of the rib structure is formed on each of at least two different stator laminations of the laminated core.

4. The stator according to claim 1, wherein the ribs of the rib structure are arranged in a grid-like pattern on the outer periphery of the laminated core.

5. A stator according to claim 1, wherein the plurality of the ribs are arranged on the outer periphery to divide the fluid path into multiple partial fluid paths.

6. The stator according to claim 1, wherein:
the plurality of the ribs is elongated and extends in a longitudinal direction, which is aligned with or parallel to the axial direction, and/or
the plurality of the ribs has a web-like shape.

7. The stator according to claim 1, wherein a length of at least one rib of the rib structure, measured along the axial direction, is at least twice, its width measured perpendicularly to the axial direction.

8. The stator according to claim 1, wherein the plurality of the ribs is arranged with axial and radial spacing from one another.

9. The stator according to claim 1, wherein a distance between two ribs neighboring in a peripheral direction, measured along the peripheral direction, is at least twice a width of at least one of these ribs, measured in the peripheral direction.

10. The stator according to claim 1, wherein:
the plurality of laminations comprises a first stator lamination and a second stator lamination axially adjacent to the first stator lamination,
the rib structure comprises first ribs of the first stator lamination and second ribs of the second stator lamination, the first ribs arranged along a peripheral direction of the stator with a distance between the first ribs, the second ribs arranged along the peripheral direction of the stator with a distance between the second ribs, and
the first ribs of the first stator lamination are arranged in the peripheral direction of the stator, offset from the second ribs of the second stator lamination.

11. The stator according to claim 10, wherein a dimension of gap, measured in the peripheral direction, between one of the first ribs and one of the second ribs adjacent to each other, is at least 0.7 times a width of the first rib and/or the second rib measured along the peripheral direction.

12. The stator according to claim 10, wherein
the plurality of laminations comprises at least two of the first lamination and at least two of the second stator laminations which are arranged consecutively along the axial direction; and/or
the laminated core comprises at least two first and at least two second stator laminations.

13. The stator according to claim 1, wherein the rib structure extends over an entire outer periphery of the laminated core.

14. The stator according to claim 1, wherein:
the housing comprises a fluid inlet for introducing the cooling medium into the fluid path and a fluid outlet for discharging the cooling medium from the fluid path; and/or
the ribs of the rib structure are configured to guide the cooling medium flows from the fluid inlet to the fluid outlet along a main flow direction, which extends either along the axial direction or along a peripheral direction of the stator that is perpendicular to the axial direction.

15. The stator according to claim 14, wherein the fluid inlet and the fluid outlet are arranged on axial end faces of the stator which are located opposite one another along the axial direction.

16. The stator according to claim 14, wherein the fluid inlet and the fluid outlet are arranged at a distance from each other on a peripheral side of the stator.

17. The stator according to claim 14, wherein the fluid inlet and the fluid outlet are arranged at a distance from one another in the axial direction and/or in the peripheral direction.

18. The stator according to claim 14, wherein:
the fluid inlet and the fluid outlet are located opposite each other in the peripheral direction; and
the fluid inlet and the fluid outlet are arranged either at the same axial height or axially offset from one another.

19. An electrical machine, comprising:
a stator comprising:
a housing surrounding a housing interior;
a laminated core comprising a plurality of laminations stacked along an axial direction, the laminated core positioned within the housing interior;
a gap between the laminated core and the housing, the gap forming a fluid path for a cooling medium to dissipate waste heat from the stator; and
a rib structure arranged on an outer periphery of the laminated core, the outer periphery defining an inner radial boundary of the fluid path,
wherein the rib structure includes a plurality of ribs that projects radially outward into the fluid path to deflect the cooling medium as the cooling medium flows; and
a rotor arranged in the housing interior, which is magnetically coupled to the stator and is configured to rotate with respect to the stator about an axis of rotation extending along the axial direction.

20. The electrical machine according to claim 19, wherein the rotor is arranged radially closer to the axis of rotation than the stator.
